(19) United States
(12) Patent Application Publication
(10) Pub. No.: US 2006/0125999 A1
(43) Pub. Date: Jun. 15, 2006

(54) Image display apparatus

(75) Inventor: Kensuke Ishii, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/299,460

(22) Filed: Dec. 12, 2005

(30) Foreign Application Priority Data
Dec. 13, 2004 (JP) 2004-360167

(51) Int. Cl. C09K 19/02

(52) U.S. Cl. 349/167

(57) ABSTRACT

There is provided an image display apparatus including an image modulation unit generating modulation light modulated in accordance with an image signal, a light path shift unit capable of shifting a light path of the modulation light generated by the image modulation unit, a projection optical unit projecting the modulation light passing through the light path shift unit on a screen, and a correction unit correcting an amount of modulation of the modulation light to be generated by the image modulation unit considering leakage light in a light path excluding a normal light path of the modulation light passing through the light path shift unit.

### CROSS-REFERENCE TO RELATED APPLICATIONS

This application is based upon and claims the benefit of priority from prior Japanese Patent Application No. 2004-360167, filed Dec. 13, 2004, the entire contents of which are incorporated herein by reference.

### BACKGROUND OF THE INVENTION

1. Field of the Invention

The present invention relates to an image display apparatus.

2. Description of the Related Art

There has been known a wobbling technique as one method of obtaining a high-resolution image projection apparatus (image display apparatus) using a display device (LCD, etc.) having limited pixels. According to the wobbling technique, pixel shift is achieved using a light path shift module comprising polarization rotation liquid crystal cell and birefringent plate.

In the foregoing wobbling technique, the shift timing of light (beam) determines in accordance with the on/off of the polarization rotation liquid crystal cell. For this reason, it is important to match the on/off timing of the polarization rotation liquid crystal cell with the display timing of the display device. For example, if TN liquid crystal is used as the polarization rotation liquid crystal cell, the response speed of the polarization rotation liquid crystal cell is not so fast. For this reason, both shift light and non-shift light are emitted from the light path shift module in a change period (rise and fall times) when the foregoing cell changes from off state to on state or from on state to off state. As a result, the light beam also arrives at a pixel position adjacent to a normal pixel position in the preceding change period. For this reason, there is a problem that cross talk and leakage light occurs.

In order to solve the foregoing problem, the following technique is disclosed in JPN. PAT. APPLN. KOKAI Publication No. 2002-281517, for example. According to the technique, red (R) and blue (B) are displayed in the beginning and end periods of one frame while green (G) is displayed in the period between them. By doing so, green (G) having high spectral luminous efficacy is displayed without overlapping with the change period of the polarization rotation liquid crystal cell. Therefore, an influence of the leakage light is reduced. However, red (R) and blue (B) are displayed overlapping with the change period. For this reason, color leakage resulting from the influence of the leakage light is not sufficiently prevented although the leakage light is visually reduced.

Thus, the image display apparatus using the wobbling technique is hard to make high-quality image display due to the leakage light in the change period of the foregoing cell.

Accordingly, an object of the present invention is to provide an image display apparatus, which can reduce an influence of the leakage light to make high-quality image display.

### BRIEF SUMMARY OF THE INVENTION

According to a first aspect of the present invention, there is provided an image display apparatus comprising: an image modulation unit generating modulation light modulated in accordance with an image signal; a light path shift unit capable of shifting a light path of the modulation light generated by the image modulation unit; a projection optical unit projecting the modulation light passing through the light path shift unit on a screen; and a correction unit correcting an amount of modulation of the modulation light to be generated by the image modulation unit considering leakage light in a light path excluding a normal light path of the modulation light passing through the light path shift unit.

In the image display apparatus, the image modulation unit generates modulation light with respect to each of colors, and the correction unit corrects an amount of modulation of modulation light with respect to each of the colors.

In the image display apparatus, the correction unit includes: a signal value operation unit correcting a luminance value of an image signal with respect to each of colors considering the leakage light; and a gain operation unit correcting a gain of the image signal corrected by the signal value operation unit so that the maximum luminance value of the image signal corrected by the signal value operation unit does not exceed the maximum luminance value displayable by the image modulation unit.

In the image display apparatus, the correction unit further includes a white balance adjustment unit adjusting a white balance with respect to the image signal having gain corrected by the gain operation unit.

In the image display apparatus, the light path shift unit includes: a polarization rotation liquid crystal cell controlling polarization rotation of the modulation light generated by the image modulation unit; and a birefringence plate on which modulation light from the polarization rotation liquid crystal cell is incident.

In the image display apparatus, the light path shift unit further includes a sensing unit acquiring response characteristic of the polarization rotation liquid crystal cell, and the correction unit changes a value of parameter used for correcting the amount of modulation of modulation light to be generated by the image modulation unit in accordance with the response characteristic acquired by the sensing unit.

In the image display apparatus, the light path shift unit further includes a drive control unit controlling a drive of the polarization rotation liquid crystal cell so that a ratio of leakage light in each light path of the modulation light becomes approximately equal to each other.

In the image display apparatus, TN liquid crystal, STN liquid crystal, vertical alignment liquid crystal or IPS liquid crystal are used for the polarization rotation liquid crystal cell.

In the image display apparatus, quartz, lithium niobate, rutile, calcite, Chile saltpeter or YVO₄ is used for the birefringent plate.

In the image display apparatus, the correction unit includes: an image processing unit carrying out image processing for eliminating an influence of the leakage light; and a select switch selecting whether or not the image processing should be made.

In the image display apparatus, the correction unit includes: an image processing unit carrying out image processing for eliminating an influence of the leakage light; and a setting unit setting a level for eliminating an influence of the leakage light in the image processing.

In the image display apparatus, the correction unit includes: an image processing unit carrying out image processing for eliminating an influence of the leakage light; an image characteristic determination unit determining image characteristic of an input image signal; and a setting unit setting a level for eliminating an influence of the leakage light in the image processing in accordance with the image characteristic determined by the image characteristic determination unit.

According to a second aspect of the present invention, there is provided a correction method for an image display apparatus comprising: an image modulation unit generating modulation light modulated in accordance with an image signal; and a light path shift unit capable of shifting a light path of the modulation light generated by the image modulation unit, the method comprising: correcting an amount of modulation of the modulation light to be generated by the image modulation unit considering leakage light in a light path excluding a normal light path of the modulation light passing through the light path shift unit.

In the method, the image modulation unit generates modulation light with respect to each of colors, and wherein correcting the amount of modulation of the modulation light includes correcting an amount of modulation of modulation light with respect to each of the colors.

In the method, correcting the amount of modulation of the modulation light includes: correcting, by a signal value operation unit, a luminance value of an image signal with respect to each of colors considering the leakage light; and correcting, by a gain operation unit, a gain of the image signal corrected by the signal value operation unit so that the maximum luminance value of the image signal corrected by the signal value operation unit does not exceed the maximum luminance value displayable by the image modulation unit.

In the method, correcting the amount of modulation of the modulation light further includes adjusting, by a white balance adjustment unit, a white balance with respect to the image signal having gain corrected by the gain operation unit.

In the method, the light path shift unit includes: a polarization rotation liquid crystal cell controlling polarization rotation of the modulation light generated by the image modulation unit; a birefringence plate on which modulation light from the polarization rotation liquid crystal cell is incident; and a sensing unit acquiring response characteristic of the polarization rotation liquid crystal cell, and correcting the amount of modulation of the modulation light includes changing a value of parameter used for correcting the amount of modulation of modulation light to be generated by the image modulation unit in accordance with the response characteristic acquired by the sensing unit.

In the method, correcting the amount of modulation of the modulation light includes: carrying out image processing for eliminating an influence of the leakage light; and selecting whether or not the image processing should be made.

In the method, correcting the amount of modulation of the modulation light includes: carrying out image processing for eliminating an influence of the leakage light; and setting a level for eliminating an influence of the leakage light in the image processing.

In the method, correcting the amount of modulation of the modulation light includes: carrying out image processing for eliminating an influence of the leakage light; determining image characteristic of an input image signal; and setting a level for eliminating an influence of the leakage light in the image processing in accordance with the determined image characteristic.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the functional configuration of an image display apparatus according to a first embodiment of the present invention;

FIG. 2 is a view showing the structure of a light path shift module according to a first embodiment of the present invention;

FIG. 3 is a view to explain a pixel shift display state according to a first embodiment of the present invention;

FIG. 4 is a view to explain the relationship between setting state and drive signal of a polarization rotation liquid crystal cell according to a first embodiment of the present invention;

FIG. 5 is a view to explain the response characteristics of the polarization rotation liquid crystal cell with respect to the setting state thereof according to a first embodiment of the present invention;

FIG. 6 is a timing chart to explain the correction method according to a first embodiment of the present invention;

FIG. 7 is a block diagram showing the configuration of a correction unit according to a first embodiment of the present invention;

FIG. 8 is a view schematically showing the structure of an image display apparatus according to a second embodiment of the present invention;

FIG. 9 is a view showing the structure of a color wheel according to a second embodiment of the present invention;

FIG. 10 is a timing chart to explain the correction method according to a second embodiment of the present invention;

FIG. 11 is a block diagram showing the configuration of a correction unit according to a second embodiment of the present invention;

FIG. 12 is a view schematically showing the structure of an image display apparatus according to a modification example of the second embodiment of the present invention;

FIG. 13 is a view schematically showing the structure of an image display apparatus according to a third embodiment of the present invention;

FIG. 14 is a timing chart to explain the correction method according to a third embodiment of the present invention;

FIG. 15 is a view schematically showing the structure of an image display apparatus according to an modification example of the third embodiment of the present invention;

FIG. 16 is a block diagram showing the functional configuration of an image display apparatus according to a fourth embodiment of the present invention;

FIG. 17 is a view showing the structure of a light path shift module sensor unit according to a fourth embodiment of the present invention;

FIG. 18 is a block diagram showing the functional configuration of an image display apparatus according to a fifth embodiment of the present invention;

FIG. 19 is a view to explain the drive control of a polarization rotation liquid crystal cell according to a fifth embodiment of the present invention;

FIG. 20 is a block diagram showing the configuration of a correction unit according to a sixth embodiment of the present invention;

FIG. 21 is a block diagram showing another configuration of the correction unit according to the sixth embodiment of the present invention; and

FIG. 22 is a block diagram showing still another configuration of the correction unit according to the sixth embodiment of the present invention.

### DETAILED DESCRIPTION OF THE INVENTION

Embodiments of the present invention will be described below with reference to the accompanying drawings.

### FIRST EMBODIMENT

FIG. 1 is a block diagram showing the functional configuration of an image display apparatus (image projection apparatus) according to a first embodiment of the present invention. In the first embodiment, a single chip type image projection apparatus is given as one example.

The image display apparatus shown in FIG. 1 is composed of correction unit 100, image modulation unit 200, light path shift unit 300 and projection optical unit 400.

The correction unit 100 has image processing unit 110 and frame memory 120. An image signal (video signal) inputted to the correction unit 100 is temporarily stored in the frame memory 120. Thereafter, the image processing unit 110 carries out predetermined image processing described later.

The image signal corrected by the correction unit 100 is supplied to the image modulation unit 200. The image modulation unit 200 comprises a LCD, for example, and modulates illumination light from a light source described later in accordance with the image signal.

The illumination light modulated by the image modulation unit 200 is supplied to the light path shift unit 300. The light path shift unit 300 makes a pixel shift using wobbling. The light path shift unit 300 is composed of light path shift module 310 and light path shift module controller 320 controlling the drive of the module 310. The light path shift module 310 comprises polarization rotation liquid crystal cell and birefringent plates (birefringent portion, birefringent material). The light path shift module 310 emits shift light and non-shift light in time sharing.

A modulated light emitted from the light path shift unit 300 is supplied to a screen (not shown) via the projection optical unit 400. Then, an image corresponding to the image in the image modulation unit 200 is enlarged and projected on the screen.

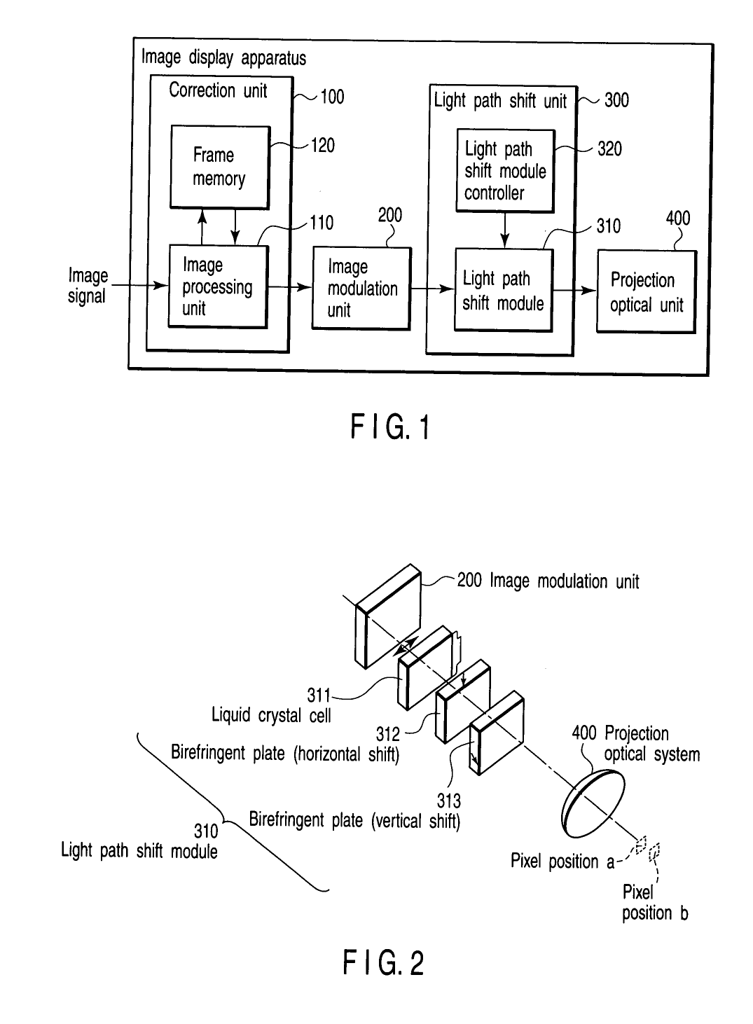

FIG. 2 is a view to explain the light path shift operation (pixel shift operation) carried out by the light path shift module 310.

The light path shift module 310 shown in FIG. 2 is composed of polarization rotation liquid crystal cell 311 capable of rotating a polarized light, birefringent plates 312 and 313.

The polarization rotation liquid crystal cell 311 comprises liquid crystal cell using TN (twisted nematic) liquid crystal. The foregoing liquid crystal cell 311 is configured to control the rotation of the polarized light in accordance with on/off of applied voltage. Specifically, if the applied voltage to the polarization rotation liquid crystal cell 311 is off, an incident light is emitted in a state of being polarized and rotated at an angle of 90°. On the other hand, if the applied voltage to the liquid crystal cell 311 is on, the incident light is emitted without being polarized and rotated. Incidentally, the foregoing liquid crystal cell 311 is not limited to the TN liquid crystal so long as it can control the rotation of the polarized light in accordance with on/off of applied voltage. For example, STN (super twisted nematic) liquid crystal, vertical alignment liquid crystal or IPS (In-Plane Switching) liquid crystal may be used.

The foregoing birefringent plates 312 and 313 separate the incident light into ordinary light (no) and extraordinary light (ne) in accordance with the polarization direction of the incident light. The following anisotropic crystals are used as the birefringent plate. For example, quartz (a-SiO₂), lithium niobate (LiNbO₃), rutile (TiO₂), calcite (CaCO₃), Chile saltpeter (NaNO₃) and YVO₄ are given. The birefringent plate 312 is configured to shift light beam by ½ pixel pitch in the horizontal direction. A vertical polarization light passes through the birefringent plate 312 as an ordinary light without shifted by the plate 312. On the other hand, a horizontal polarization light is shifted to the horizontal direction as an extraordinary light by the birefringent plate 312. The birefringent plate 313 is configured to shift light beam by ½ pixel pitch in the vertical direction. The horizontal polarization light passes through the birefringent plate 313 as an ordinary light without shifted by the plate 313. On the other hand, the vertical polarization light is shifted to the vertical direction as an extraordinary light by the birefringent plate 313.

The operation when on voltage is applied to the polarization rotation liquid crystal cell 311 will be explained below. The image modulation unit 200 emits a polarization light having a horizontal polarization transmission axis as an image light (modulation light). The on voltage is applied to the liquid crystal cell 311; therefore, the polarization light having a horizontal polarization transmission axis passes through the cell 311 without being rotated by the cell 311. The polarization light emitted from the liquid crystal cell 311 is shifted to the horizontal direction by the birefringent plate 312, and passes through there. The polarization light from the birefringent plate 312 passes through the birefringent plate 313 without being shifted by the plate 313. As a result, the image light beam arrives at a pixel position “a” on the screen.

The operation when off voltage is applied to the polarization rotation liquid crystal cell 311 will be explained below. The image modulation unit 200 emits a polarization light having a horizontal polarization transmission axis as an image light (modulation light). The off voltage is applied to the liquid crystal cell 311; therefore, the polarization light having a horizontal polarization transmission axis is rotated at an angle of 90° by the liquid crystal cell 311. Thus, a polarization light having a vertical polarization transmission axis is emitted from the liquid crystal cell 311. The polarization light emitted from the liquid crystal cell 311 passes through the birefringent plate 312 without being shifted by the plate 312. The polarization light from the birefringent plate 312 is shifted to the vertical direction by the birefringent plate 313, and passes through there. As a result, the image light beam arrives at a pixel position “b” on the screen.

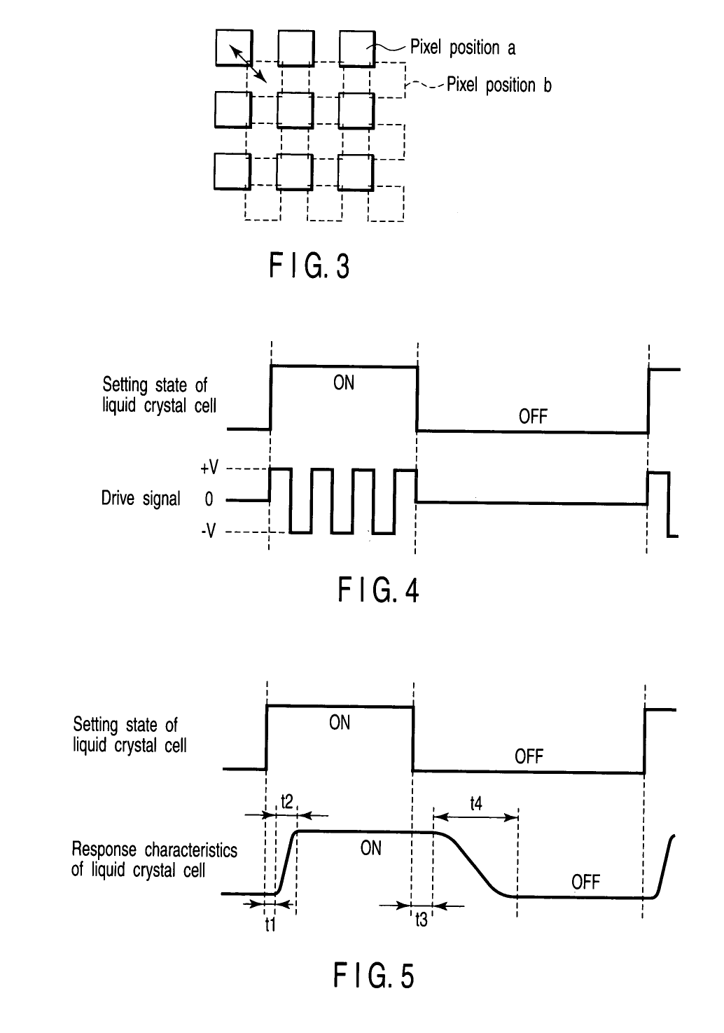

As seen from the foregoing description, the on/off state of the liquid crystal cell 311 is switched, and thereby, it is possible to carry out control whether or not the shift operation by birefringent plates 312 and 313 is made. Thus, the on/off state of the liquid crystal cell 311 is switched in synchronous with the modulating timing of the image modulation unit 200. By doing so, display states made on the pixel positions “a” and “b” are synthesized in a time axis direction, as shown in FIG. 3. As a result, an image having pixels twice the pixels of the image modulation unit 200 is displayed on the screen.

FIG. 4 is a view to explain the relationship between setting state (on state, off state) and drive signal of the polarization rotation liquid crystal cell 311. In the on state, ±V (volt) alternating voltage is applied to the cell 311; on the other hand, in the off state, 0 (volt) voltage is applied to the cell 311.

FIG. 5 is a view to explain the response characteristics of the polarization rotation liquid crystal cell 311 with respect to the setting state thereof. As shown in FIG. 5, the liquid crystal cell 311 has the following setting states. One is a period (rise time) when the liquid crystal cell 311 changes from an off state to an on state. Another is a period (fall time) when the liquid crystal cell 311 changes from the on state to the off state. In the foregoing periods, time is taken until the liquid crystal cell 311 becomes stable. In this case, the following times are preset. One is a rise response delay time t1 until the liquid crystal cell 311 starts response after on voltage is applied to the cell 311. Another is a rise change time t2 until the liquid crystal cell 311 reaches a stable on state after it starts response. Another is a fall response delay time t3 until the liquid crystal cell 311 starts response after off voltage is applied to the cell 311. Another is a rise change time t4 until the liquid crystal cell 311 reaches a stable off state after it starts response.

As seen from FIG. 5, when the setting state of the liquid crystal cell 311 is changed, rise and fall change times t2 and t4 exist. In the foregoing change times t2 and t4, the liquid crystal cell 311 becomes an intermediate state between on and off states. For this reason, light having horizontal and vertical polarization components is emitted from the liquid crystal cell 311. As a result, the image light passing through birefringent plates 312 and 313 arrives at pixel positions “a” and “b”. Specifically, when the liquid crystal cell 311 is in an on state, the image light should inherently arrive at the pixel position “a” only. Nevertheless, the image light arrives at the pixel position “b” as leakage light. Likewise, when the liquid crystal cell 311 is in an off state, the image light should inherently arrive at the pixel position “b” only. Nevertheless, the image light arrives at the pixel position “a” as leakage light. Thus, the foregoing leakage light hinders proper high-quality image display. According to the first embodiment, the following correction is made to obtain proper high-quality image display.

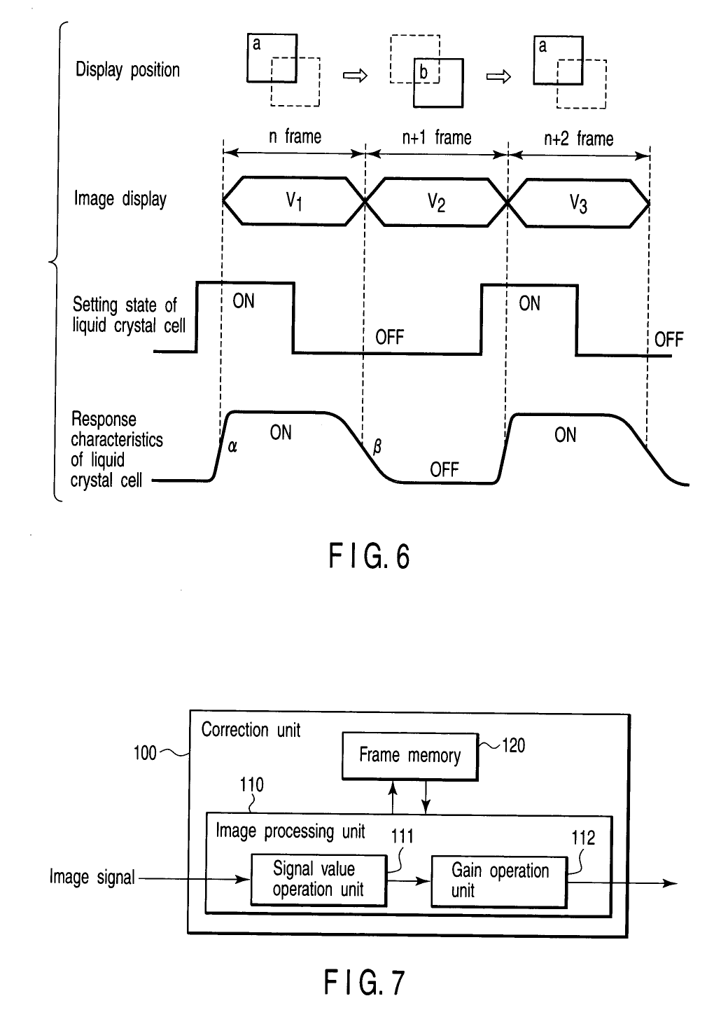

FIG. 6 is a timing chart to explain the correction method according to a first embodiment. As depicted in FIG. 6, an image is displayed on the pixel position “a” in an n frame, displayed on the pixel position “b” in an n+1 frame, and displayed on the pixel position “a” in an n+2 frame. A ratio of leakage light when the frame is changed in the rise change time of the liquid crystal cell 311 is set as α. A ratio of leakage light when the frame is changed in the fall change time of the liquid crystal cell 311 is set as β.

If it is assumed that there is no influence of the leakage light, a luminance value of the image displayed on the pixel position “a” in the n frame is set as V₁. Moreover, a luminance value of the image displayed on the pixel position “b” in the n+1 frame is set as V₂. In other words, if no leakage light exist and display is made at a luminance value corresponding to the image signal, the luminance values at the pixel positions “a” and “b” are set as V₁ and V₂. However, the foregoing leakage light is generated in fact. Thus, considering the influence of the leakage light, a luminance value Va at the pixel position “a” in n frame and n+1 frame is expressed by the following equation (1). Likewise, a luminance value Vb at the pixel position “b” in n frame and n+1 frame is expressed by the following equation (2).
Va=V₁−αV₁−βV₁+βV₂+αV₂ (1)
Vb=V₂−αV₂−βV₂+βV₁α+V₁ (2)

Namely, if the influence of the leakage light exists, display of the pixel position “a” is made at the luminance value expressed by the equation (1) while display of the pixel position “b” is made at the luminance value expressed by the equation (2).

When determining V₁ and V₂ from the foregoing equations (1) and (2), the luminance values V₁ and V₂ are expressed by following equations (3) and (4), respectively.
V₁=[(1−α−β)Va−(α+β)Vb]/[(1−α−β)²−(α+β)²] (3)
V₂=[(1−α−β)Vb−(α+β)Va]/[(1−α−β)²−(α+β)²] (4)

Considering the influence of the leakage light, the luminance value at the pixel position “a” is Va; on the other hand, the luminance value at the pixel position “b” is Vb. Therefore, the luminance values V₁ and V₂ are determined from the equations (3) and (4) to supply image signals corresponding to these luminance values V₁ and V₂ to the image modulation unit. By doing so, it is possible to make proper high-quality image display reducing the influence of the leakage light.

The foregoing matter will be explained below with reference to the block diagram of FIG. 1. The correction unit 100 is supplied with an image signal having the luminance value Va as a signal of the image, which should be displayed on the pixel position “a” in the n frame. The correction unit 100 is supplied with an image signal having the luminance value Vb as a signal of the image, which should be displayed on the pixel position “b” in the n+1 frame. Considering the foregoing ratios α and β of the leakage light, the image processing unit 110 calculates luminance values V₁ and V₂ from the equations (3) and (4). The image signal having these luminance values V₁ and V₂ is supplied to the image modulation unit 200 as a corrected image signal. The image modulation unit 200 modulates an illumination light based on the corrected image signal. By doing so, it is possible to make proper image display reducing an influence of leakage light.

If the foregoing correction is made, there exists the case where luminance values V₁ and V₂ of the corrected image signal exceed the maximum luminance value displayable by the image modulation unit 200. In such a case, gain correction is made so that the maximum luminance value of the corrected image signal does not exceed the maximum luminance value displayable by the unit 200.

When the maximum luminance value displayable by the unit 200 is set as MaxVal, and the maximum luminance value of the corrected image signal is set as Max(Vi), a gain correction coefficient C is expressed by the following equation (5).
C=MaxVal/Max(Vi) (5)

Therefore, luminance values V′₁ and V′₂ of an image signal supplied to the unit 200 after gain correction are expressed by the following equations (6) and (7), respectively.

V′₁=C·V₁ (6)
V′₂=C·V₂ (7)

FIG. 7 is a block diagram showing the configuration of the correction unit 100 for carry out the foregoing processing. The image processing unit 110 is provided with a signal value operation unit 111 and gain operation unit 112. The signal value operation unit 111 calculates luminance values (corresponding to V₁ and V₂) considering the influence of the leakage light. The gain operation unit 112 calculates gain-corrected luminance values (corresponding to V′₁ and V′₂). Thus, an image signal having gain-corrected luminance values (V′₁ and V′₂) is supplied to the image modulation unit 200.

In the foregoing manner, gain correction is made, and thereby, proper high-quality image display can be obtained even if the corrected luminance value of the image signal exceeds the maximum luminance value displayable by the unit 200.

### SECOND EMBODIMENT

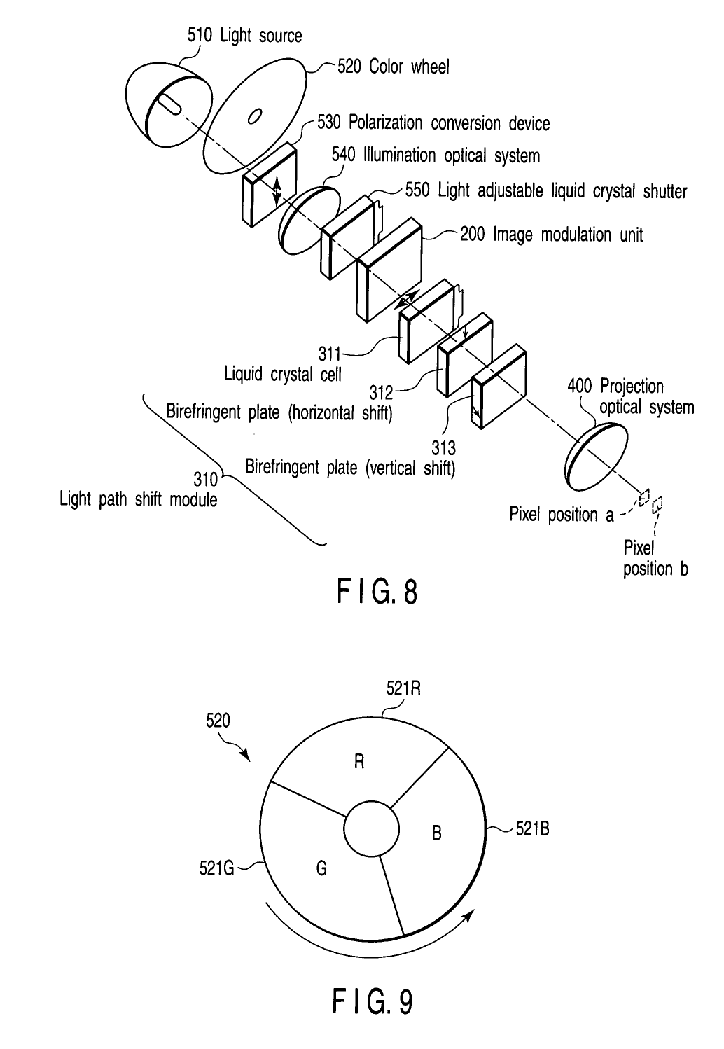

FIG. 8 is a view schematically showing the structure of an image display apparatus (image projection apparatus) according to a second embodiment of the present invention. In the following description, the functional configuration is basically the same as FIG. 1; therefore, the detailed explanation is omitted.

In the first embodiment, the single chip type image projection apparatus is given as one example. According to the second embodiment, illumination light of red (R), green (G) and blue (B) from an illumination unit is supplied to the image modulation unit 200 in time sharing to display a color image.

A light (illumination) source 510 generates a white light; for example, a discharge lamp is used. The emission side of the light source 510 is provided with a color wheel 520. The color wheel 520 has R filter 521R transmitting R (red) light, G filter 521G transmitting G (green) light and B filter 521b transmitting B (blue) light, as illustrated in FIG. 9. The color wheel 520 is rotated so that the illumination light from the light source 510 passes through the foregoing R, G and B filters 521R, 521G and 521B in succession.

The emission side of the color wheel 520 is provided with polarization conversion device (PS conversion device) 530, illumination optical system 540 and light-quantity adjustable liquid crystal shutter 550. The polarization conversion device 530 converts light having no specific polarization direction from the light source into light having specific polarization direction (vertical direction in this embodiment). The liquid crystal shutter 550 adjusts a ratio of light from each filter of the color wheel 520.

The image modulation unit 200 comprises a transmission type LCD, like the first embodiment. An emission light color is determined in accordance with filters of the color wheel 520. The incident side of the transmission type LCD is provided with a polarization plate (not shown) having a vertical polarization transmission axis. The emission side of the transmission type LCD is provided with a polarization plate (not shown) having a horizontal polarization transmission axis. Therefore, the emission light from the image modulation unit 200 becomes polarization light having a horizontal polarization transmission axis.

The polarization light (modulation light) from the image modulation unit 200 is incident on the light path shift module 310. The structure and operation of the light path shift module 310 is basically the same as FIG. 2 described in the first embodiment; therefore, the detailed explanation is omitted here. Projection light from the light path shift module 310 is projected on a screen (not shown) via the projection optical system 400. Display is made at pixel positions “a” and “b” on the screen.

As described in the first embodiment, in the change period when the setting state of the liquid crystal cell 311 is changed, the cell 311 is in an intermediate state between on and off states. For this reason, proper image display is hindered due to the influence of leakage light. According to the second embodiment, the following correction is made to obtain proper image display.

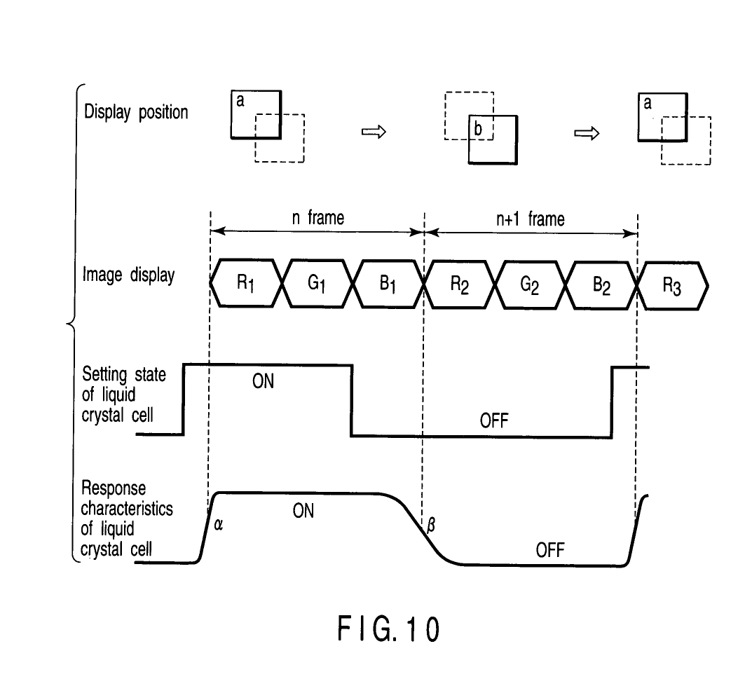

FIG. 10 is a timing chart to explain the correction method according to the second embodiment. As shown in FIG. 10, R, G and B images are displayed on the pixel position “a” in an n frame; on the other hand, R, G and B images are displayed on the pixel position “b” in an n+1 frame. Like the first embodiment, a ratio of leakage light when the frame is changed in the rise change time of the liquid crystal cell 311 is set as α. A ratio of leakage light when the frame is changed in the fall change time of the liquid crystal cell 311 is set as β.

As described in the first embodiment, if it is assumed that there is no influence of leakage light, a luminance value of the R image displayed on the pixel position “a” in the n frame is set as R₁. A luminance value of the R image displayed on the pixel position “b” in the n+1 frame is set as R₂. However, in fact, leakage light exists; for this reason, the influence of leakage light must be considered. Therefore, a luminance value Ra of the R image displayed on the pixel position “a” in n and n+1 frames and a luminance value Rb of the R image displayed on the pixel position “b” in the same as above are expressed by the following equations (8) and (9), respectively.
Ra=R₁−αR₁+βR₂ (8)
Rb=R₂−βR₂+αR₁ (9)

In other words, if there is an influence of leakage light, the R image is displayed on the pixel position “a” at the luminance value expressed by the equation (8). Simultaneously, the R image is displayed on the pixel position “b” at the luminance value expressed by the equation (9).

Thus, when calculating R₁ and R₂ based on the foregoing equations (8) and (9), R₁ and R₂ are expressed by the following equations (10) and (11), respectively.
R₁=[(1−β)Ra−βRb]/(1−α−β) (10)
R₂=[(1−α)Rb−αRa]/(1−α−β) (11)

The B image is obtained in the same manner as above. Specifically, luminance values Ba and Bb of the B image are expressed by the following equations (12) and (13), respectively.
Ba=B₁−βB₁+αB₂ (12)
Bb=B₂−αB₂+βB₁ (13)

In other words, if there is an influence of leakage light, the B image is displayed on the pixel position “a” at the luminance value expressed by the equation (12). Simultaneously, the B image is displayed on the pixel position “b” at the luminance value expressed by the equation (13).

Thus, when calculating B₁ and B₂ based on the foregoing equations (12) and (13), B₁ and B₂ are expressed by the following equations (14) and (15), respectively.
B₁=[(1−α)Ba−αBb]/(1−α−β) (14)
B₂=[(1−β)Bb−βBa]/(1−α−β) (15)

On the other hand, the influence of leakage light has no need to be considered because the G image is not displayed in the rise and fall change time of the liquid crystal cell 311. That is, G1=Ga, G2=Gb; therefore, no correction is made taking the influence of leakage light into consideration.

As described above, according to the second embodiment, luminance values R1 and R2 are calculated from equations (10) and (11) while luminance values B1 and B2 are calculated from equations (14) and (15). Thus, each image signal corresponding to luminance values R1, R2, B1 and B2 is supplied to the image modulation unit. By doing so, it is possible to make proper high-quality image display reducing the influence of leakage light, like the first embodiment.

If the foregoing correction is made, there exists the case where luminance values R1, R2, B1 and B2 of the corrected image signal exceed the maximum luminance value displayable by the image modulation unit 200, as described in the first embodiment. In such a case, gain correction is made so that the maximum luminance value of the corrected image signal does not exceed the maximum luminance value displayable by the unit 200, like the first embodiment.

When the maximum luminance value displayable by the unit 200 is set as MaxVal, and the maximum luminance value of the image signal of the corrected R and B images is set as Max(Ri, Bi), a gain correction coefficient C is expressed by the following equation (16).
C=MaxVal/Max(Ri,Bi) (16)

Therefore, luminance values R′₁, R′₂, B′₁ and B′₂ of an image signal supplied to the unit 200 after gain correction are expressed by the following equations (17) to (20), respectively.
R′₁=C·R₁ (17)
R′₂=C R₂ (18)
B′₁=C·B₁ (19)
B′₂=C·B₂ (20)

However, gain correction is made with respect to R and B images while it is not made with respect to G image; in this case, there is a possibility that white balance is broken down. Thus, when gain correction is made with respect to the G image, luminance values G′₁, and G′₂ are expressed by the following equations (21) and (22), respectively.
G′₁=C·G₁ (21)
G′₂=C·G₂ (22)

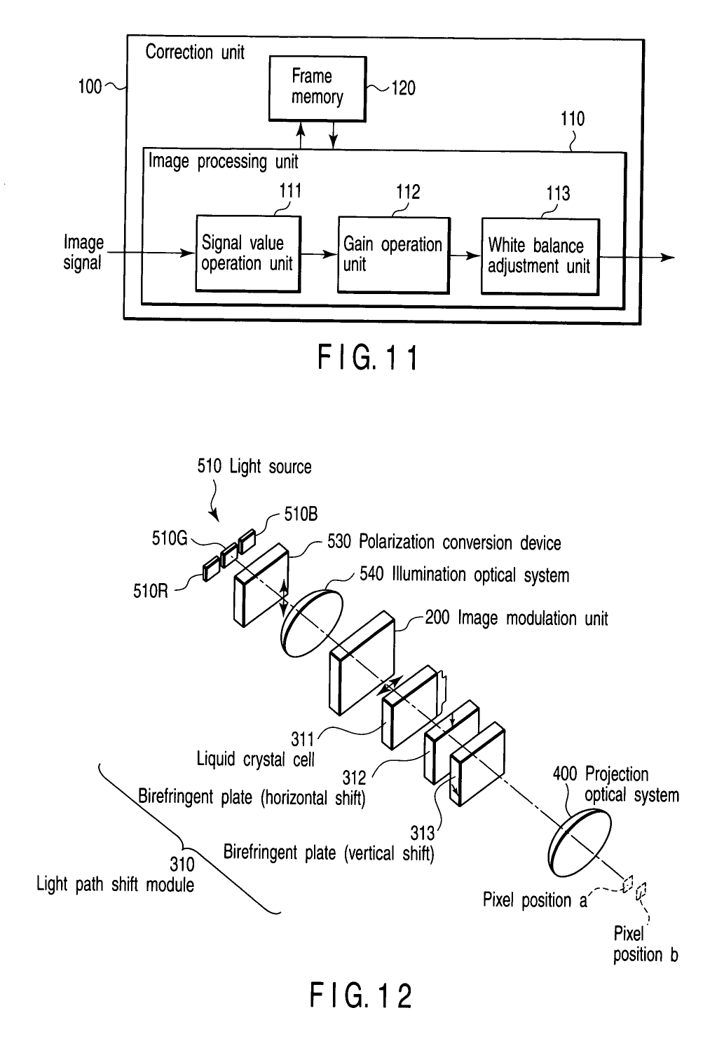

FIG. 11 is a block diagram showing the configuration of the correction unit 100 for carry out the foregoing processing. The image processing unit 110 is provided with a signal value operation unit 111, gain operation unit 112 and white balance adjustment unit 113. The signal value operation unit 111 calculates luminance values (corresponding to R₁, R₂, B₁ and B₂) considering the influence of the leakage light. The gain operation unit 112 calculates gain-corrected luminance values (corresponding to R′₁, R′₂, B′₁ and B′₂). The white balance adjustment unit 113 calculates white balance-adjusted luminance values (corresponding to R′₁, R′₂, B′₁, B′₂, G′₁ and G′₂). Thus, an image signal having white balance-adjusted luminance values is supplied to the image modulation unit 200.

In the foregoing manner, gain correction and white balance adjustment are made, and thereby, proper high-quality image display can be obtained even if the corrected luminance value of the image signal exceeds the maximum luminance value displayable by the unit 200.

FIG. 12 is a view schematically showing the structure of an image display apparatus according to a modification example of the second embodiment. According to the structure shown in FIG. 8, R, G and B illumination lights are supplied to the image modulation unit 200 in time sharing using the light source 510 generating white light and the color wheel 520. According to this modification example, a light source (LED light source) 510 comprising R, G and B light emitting portions 510R, 510G and 510B is used. The foregoing R, G and B light emitting portions 510R, 510G and 510B are successively emitted, and thereby, illumination light is supplied to the image modulation unit 200 in time sharing. Other structure is basically the same as FIG. 8. Even if the foregoing structure is employed, it is possible to make proper high-quality image display reducing the influence of leakage light.

### THIRD EMBODIMENT

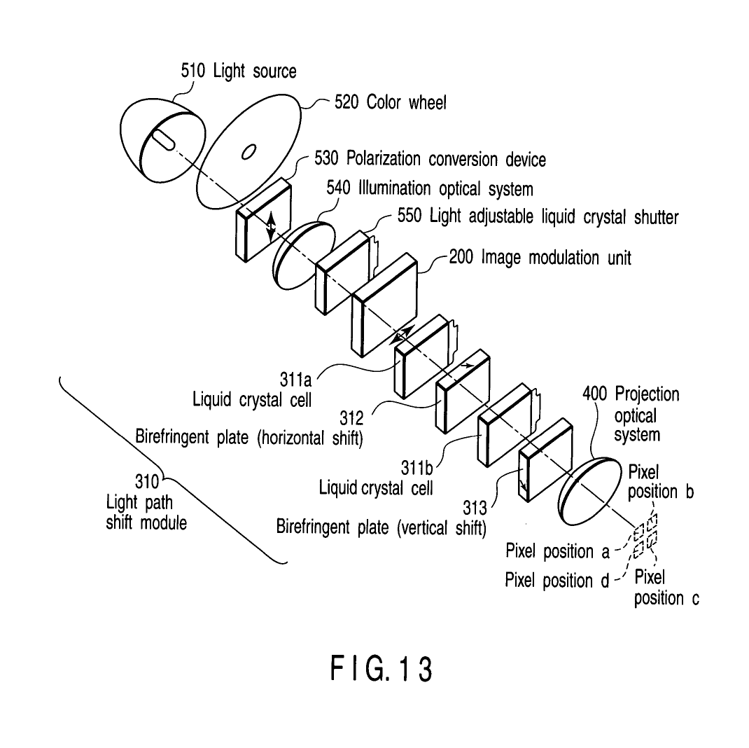

FIG. 13 is a view schematically showing the structure of an image display apparatus (image projection apparatus) according to a third embodiment of the present invention. The function and configuration of the third embodiment is basically the same as the first and second embodiments; therefore, the detailed explanation is omitted.

In the second embodiment, two-point pixel shift has been given as one example. The third embodiment relates to four-point pixel shift. Therefore, the light path shift module 310 is composed of two polarization rotation liquid crystal cells 311a, 311b, two birefringent plates 312 and 313.

The following is an explanation about the operation of the case where off voltage is applied to liquid crystal cells 311a and 311b. As depicted in FIG. 13, the image modulation unit 200 emits polarization light having a horizontal polarization transmission axis as an image light (modulation light). Since off voltage is applied to the liquid crystal cell 311a, the polarization light having a horizontal polarization transmission axis is rotated at an angle of 90° by the liquid crystal cell 311a. Thus, polarization light having a vertical polarization transmission axis is emitted from the liquid crystal cell 311a. Therefore, the polarization light emitted from the liquid crystal cell 311a passes through the birefringent plate 312 without being shifted by the plate 312. Since off voltage is applied to the liquid crystal cell 311b, the polarization light having a vertical polarization transmission axis is rotated at an angle of 90° by the liquid crystal cell 311b. Thus, polarization light having a horizontal polarization transmission axis is emitted from the liquid crystal cell 311b. Therefore, the polarization light emitted from the liquid crystal cell 311b passes through the birefringent plate 313 without being shifted by the plate 313. As a result, the image light beam arrives at a pixel position “a” on the screen.

Although a detailed explanation is omitted, when on voltage is applied to liquid crystal cells 311a and 311b, the image light beam arrives at a pixel position “b” on the screen. Moreover, when on voltage is applied to the liquid crystal cell 311a while off voltage is applied to the liquid crystal cell 311b; the image light beam arrives at a pixel position “c” on the screen. Moreover, when off voltage is applied to the liquid crystal cell 311a while on voltage is applied to the liquid crystal cell 311b; the image light beam arrives at a pixel position “d” on the screen.

Therefore, an image having pixels four times as much as the pixels of the image modulation unit 200 is displayed on the screen.

As described in the first embodiment, in the change period when the setting state of the liquid crystal cell is changed, the cell is in an intermediate state between on and off states. For this reason, proper image display is hindered due to the influence of leakage light. According to the third embodiment, the following correction is made to obtain proper image display.

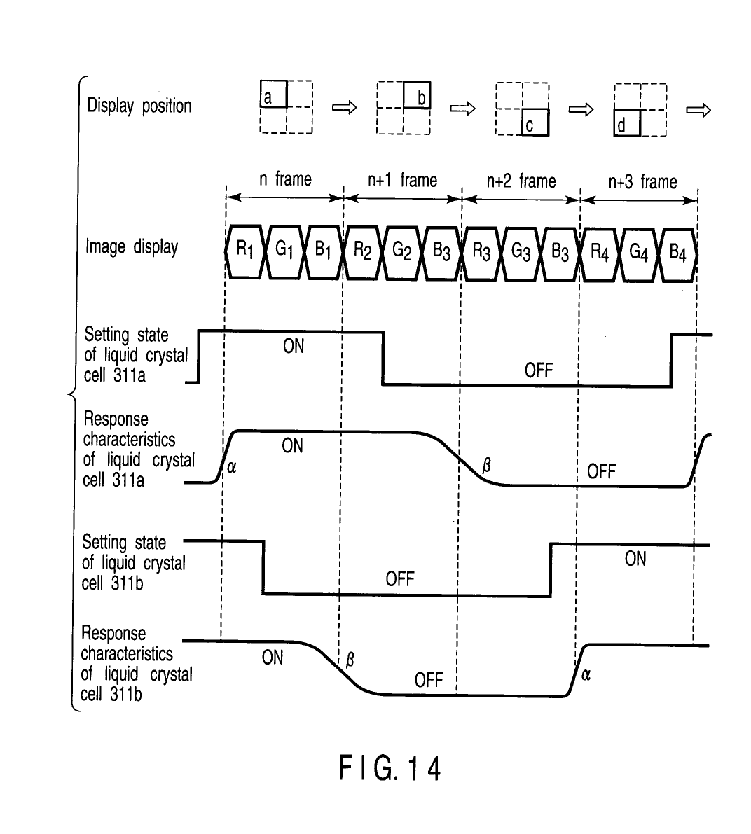

FIG. 14 is a timing chart to explain the correction method according to the third embodiment. As shown in FIG. 14, R, G and B images are displayed on the pixel position “a” in an n frame, and R, G and B images are displayed on the pixel position “b” in an n+1 frame. Moreover, R, G and B images are displayed on the pixel position “c” in an n+2 frame, and R, G and B images are displayed on the pixel position “d” in an n+3 frame. Like the first embodiment, a ratio of leakage light when the frame is changed in the rise change time of the liquid crystal cells 311a and 311b is set as α. A ratio of leakage light when the frame is changed in the fall change time of the liquid crystal cells 311a and 311b is set as β.

As described in the first and second embodiment, if it is assumed that there is no influence of leakage light, a luminance value of the R image displayed on the pixel position “a” in the n frame is set as R₁. A luminance value of the R image displayed on the pixel position “b” in the n+1 frame is set as R₂. Moreover, a luminance value of the R image displayed on the pixel position “c” in the n+2 frame is set as R₃. A luminance value of the R image displayed on the pixel position “d” in the n+3 frame is set as R₄. However, in fact, leakage light exists; for this reason, the influence of leakage light must be considered. Therefore, luminance values Ra, Rb, Rc and Rd of the R image displayed on the pixel positions “a”. “b”, “c” and “d” in n, n+1, n+2 and n+3 frames are expressed by the following equations (23) to (26), respectively.
Ra=R₁−αR₁+βR₂ (23)
Rb=R₂−βR₂+βR₃ (24)
Rc=R₃−βR₃+αR₄ (25)
Rd=R₄−αR₄+αR₁ (26)

The B image is obtained in the same manner as above. Specifically, luminance values Ba to Bd of the B image are expressed by the following equations (27) to (30), respectively.
Ba=B₁−βB+αB₂ (27)
Bb=B₂−βB₂+βB₃ (28)
Bc=B₃−αB₃+βB₄ (29)
Bd=B₄−αB₄+αB₁ (30)

On the other hand, the influence of leakage light has no need to be considered because the G image is not displayed in the rise and fall change time of the liquid crystal cell. That is, G1=Ga, G2=Gb, G3=Gc, G4=Gd; therefore, no correction is made taking the influence of leakage light into consideration.

Like the first and second embodiments, luminance values R1 to R4 are calculated from equations (23) to (26) while luminance values B1 to B4 are calculated from equations (27) to (30). Thus, each image signal corresponding to luminance values R1 to R4 and B1 to B4 is supplied to the image modulation unit. By doing so, it is possible to make proper high-quality image display reducing the influence of leakage light, like the first and second embodiments.

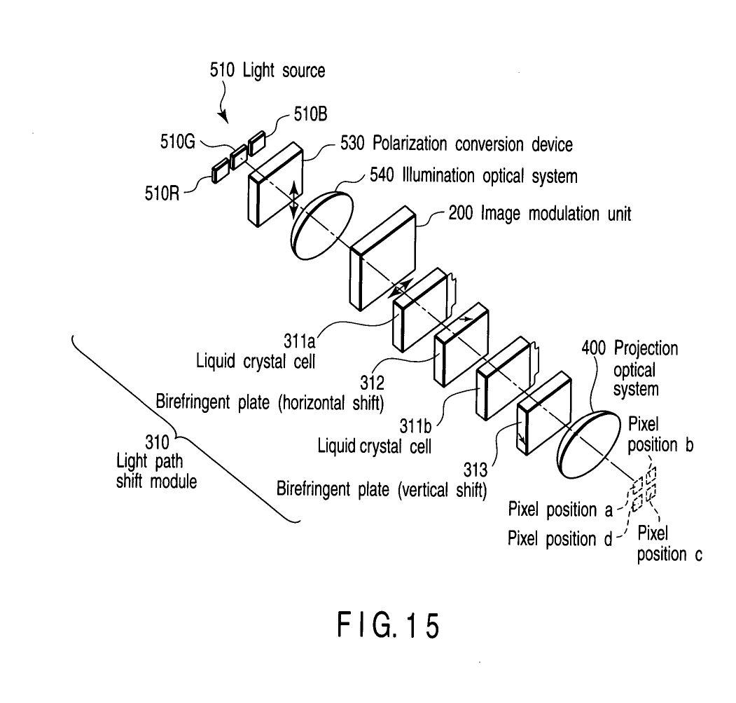

In the third embodiment, gain correction and white balance adjustment may be made like the second embodiment. In addition, a light source (LED light source) 510 comprising R, G and B light emitting portions 510R, 510G and 510B may be used as seen from FIG. 15, like the second embodiment.

### FOURTH EMBODIMENT

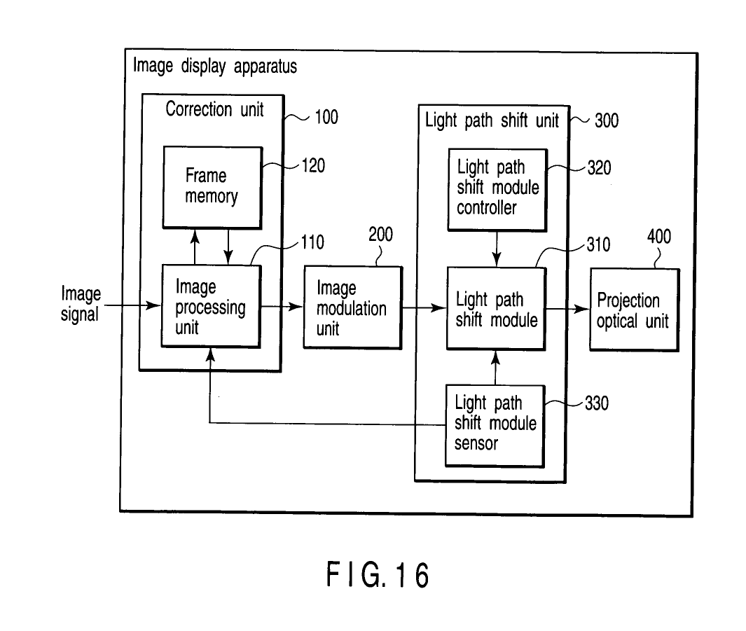

FIG. 16 is a block diagram showing the functional configuration of an image display apparatus (image projection apparatus) according to a fourth embodiment of the present invention. The basic configuration is the same as described in the first to third embodiments; therefore, the detailed explanation is omitted.

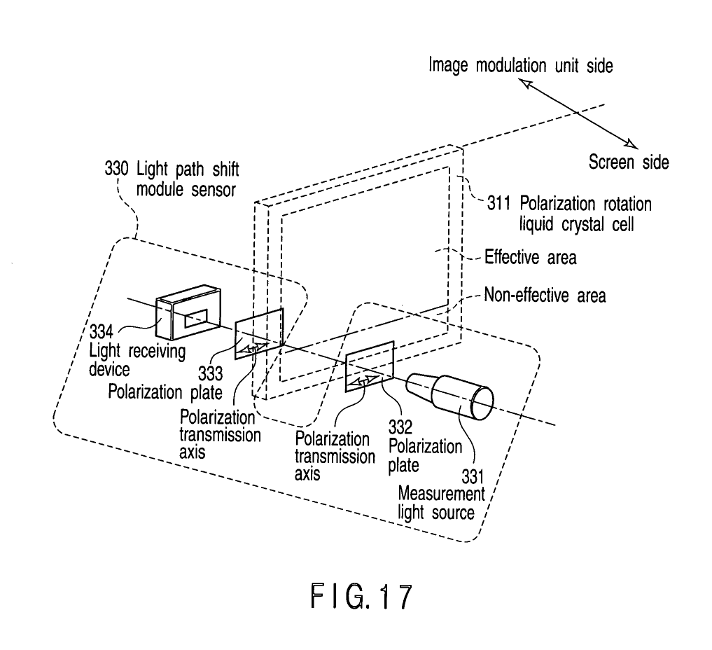

According to the fourth embodiment, the light path shift unit 300 is provided with a light path shift module sensor 330. FIG. 17 is a view showing the structure of the light path shift module sensor 330.

The light path shift module sensor 330 includes measurement light source 331, polarization plates 332, 333 and light receiving device 334. Measurement light emitted from the measurement light source 331 is incident on the light receiving device 334 via polarization plate 332, liquid crystal cell 311 and polarization plate 333. The light path shift module sensor 330 is provided, and thereby, the response characteristic of the liquid crystal cell 311 can be measured.

The measurement light from the measurement light source 331 comprising an LED is arranged in one direction in its polarization direction, and thereafter, supplied to the liquid crystal cell 311. The polarization plate 333 is arranged at the position facing the polarization plate 332 via the liquid crystal cell 311. The foregoing polarization plates 332 and 333 are arranged so that their polarization transmission axis is the identical direction. The measurement light passing through the polarization plate 333 is incident on the light receiving device 334 comprising a photo diode. The light receiving device 334 outputs a photoelectric conversion signal in accordance with an amount of received measurement light. The photoelectric conversion signal corresponds to response characteristic of the polarization rotation liquid crystal cell 311.

The response characteristic of the liquid crystal cell 311 changes in accordance with temperature or the like. For this reason, the ratios α and β of the leakage light described in FIG. 6 change in accordance with temperature or the like. According to the fourth embodiment, the image processing unit 110 calculates the foregoing ratios α and β based on the response characteristic acquired by the light path shift module sensor 330. Then, the ratios α and β thus calculated are reflected in equations described before. In other words, parameters α and β are changed in accordance with a change of response characteristic.

According to the fourth embodiment, the light path shift module sensor 330 is provided, and thereby, optimum correction operation is made in accordance with a change of response characteristic of the liquid crystal cell 311, that is, a change of parameters α and β. Therefore, it is possible to make proper high-quality image display always and securely reducing an influence of leakage light.

The light path shift module sensor 330 is arranged outside the area where the modulation light modulated by the image modulation unit passes, as seen from FIG. 17. Specifically, the sensor 330 is arranged in a non-effective area excluding an effective area where a projection light (image light) from the image modulation unit passes. As described above, the light path shift module sensor 330 is arranged in a non-effective area. By doing so, the response characteristic of the liquid crystal cell 311 can be measured without giving any influence to the image light. Therefore, it is possible to always acquire the response characteristic of the liquid crystal cell 311 in real time even for the duration when image display is made.

### FIFTH EMBODIMENT

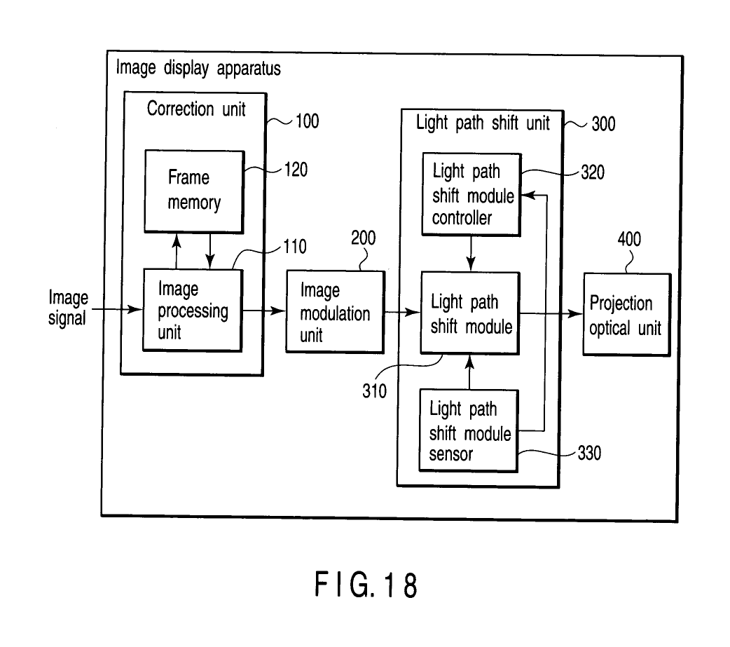

FIG. 18 is a block diagram showing the functional configuration of an image display apparatus (image projection apparatus) according to a fifth embodiment of the present invention. The basic configuration is the same as described in the first to third embodiments; therefore, the detailed explanation is omitted.

In the fifth embodiment, the light path shift module sensor 330 shown in FIG. 17 is provided like the foregoing fourth embodiment. According to the fifth embodiment, the light path shift module controller 320 carries out the following control based on response characteristic of the liquid crystal cell 311 acquired by the sensor 330. Namely, the controller 320 controls the drive of the liquid crystal cell 311 so that ratios of leakage light in each light path of the modulation light (i.e., α and β values) become approximately equal.

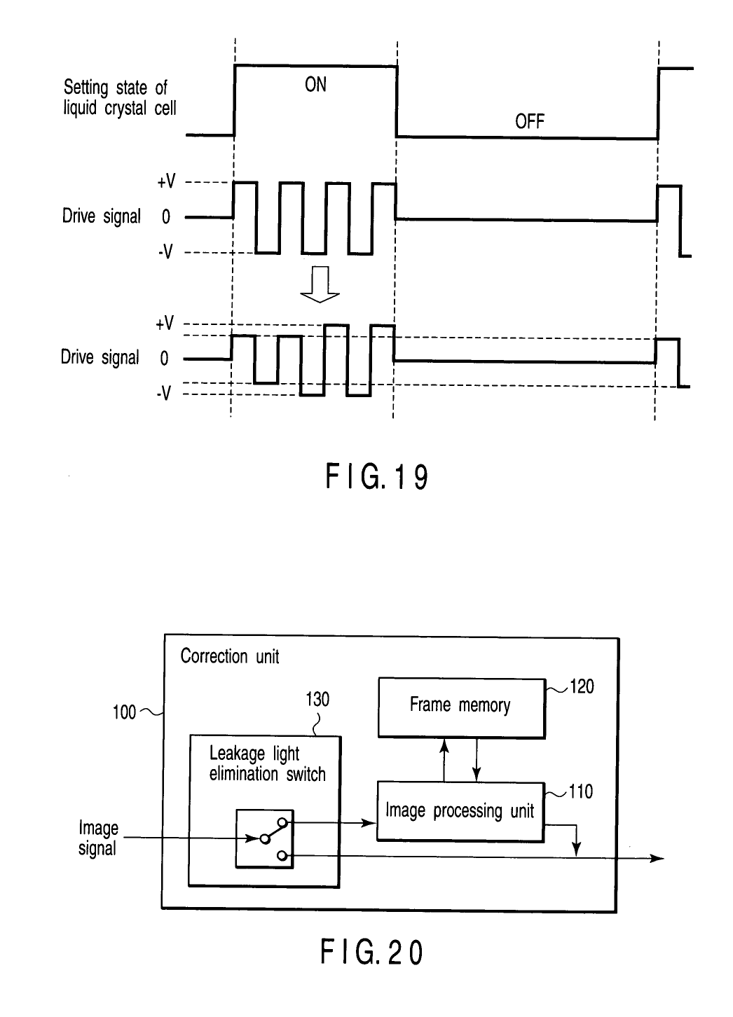

FIG. 19 is a view to explain the drive control of a polarization rotation liquid crystal cell 311. According to the control shown in FIG. 19, drive signal voltage is changed (e.g., voltage value is gradually changed). By doing so, rise and fall characteristics of the liquid crystal cell 311 are changed to carry out control so that α and β values become approximately equal. In this case, the drive signal frequency or the ratio of on and off time may be changed to carry out control so that α and β values become approximately equal.

As described above, according to the fifth embodiment, the drive of the liquid crystal cell 311 is controlled so that α and β values become approximately equal. By doing so, the relation of α=β is given; therefore, the equations described before are simplified. This serves to simplify the configuration of the correction unit 100 (in particular, image processing unit 110).

### SIXTH EMBODIMENT

According to the foregoing embodiments, the influence of leakage light is reduced as much as possible. However, the influence of leakage light is reduced, and thereby, there is a possibility that contrast is reduced although image fidelity is improved. According to the sixth embodiment, the following configuration is employed to make desired or accurate image display.

FIG. 20 is a block diagram showing the first configuration according to the sixth embodiment. According to the first configuration, the correction unit 100 is provided with a leakage light elimination switch (select switch) 130. The switch 130 is connected to the image processing unit 110, and thereby, correction is made to eliminate the influence of leakage light described in the foregoing embodiments. If the switch 130 is separated from the image processing unit 110, the foregoing correction is not made. Therefore, the first configuration is employed, and thereby, image display is accurately made in accordance with user's needs (e.g., user desire to preferentially make which of image fidelity or contrast).

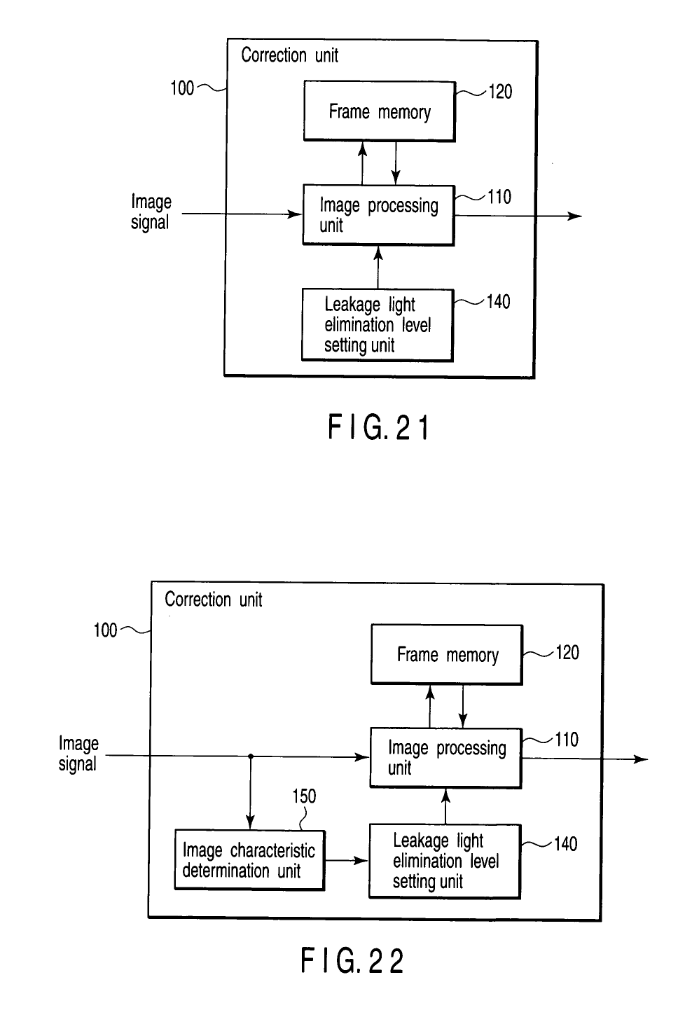

FIG. 21 is a block diagram showing the second configuration according to the sixth embodiment. According to the second configuration, the correction unit 100 is provided with a leakage light elimination level setting unit 140. The setting unit 140 sets a leakage light elimination level (range from 0% to 100%) to a desired level. By doing so, the balance between image fidelity and contrast is acutely set; therefore, accurate image display can be made.

FIG. 22 is a block diagram showing the third configuration according to the sixth embodiment. According to the third configuration, the correction unit 100 is provided with leakage light elimination level setting unit 140 and image characteristic determination unit 150. The image characteristic determination unit 150 determines image characteristic (e.g., kind of images) from the image signal. The leakage light elimination level setting unit 140 sets a leakage light elimination level based on the determination result. The foregoing configuration is employed, and thereby, a proper leakage light elimination level is automatically set in accordance with the image characteristic; therefore, accurate image display can be made.

According to the present invention, an amount of modulation of the modulation light is corrected considering the leakage light. By doing so, it is possible to make proper high-quality image display reducing the influence of leakage light.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display apparatus comprising:
an image modulation unit generating modulation light modulated in accordance with an image signal;
a light path shift unit capable of shifting a light path of the modulation light generated by the image modulation unit;
a projection optical unit projecting the modulation light passing through the light path shift unit on a screen; and
a correction unit correcting an amount of modulation of the modulation light to be generated by the image modulation unit considering leakage light in a light path excluding a normal light path of the modulation light passing through the light path shift unit.

2. The apparatus according to claim 1, wherein the image modulation unit generates modulation light with respect to each of colors, and the correction unit corrects an amount of modulation of modulation light with respect to each of the colors.

3. The apparatus according to claim 1, wherein the correction unit includes:
a signal value operation unit correcting a luminance value of an image signal with respect to each of colors considering the leakage light; and
a gain operation unit correcting a gain of the image signal corrected by the signal value operation unit so that the maximum luminance value of the image signal corrected by the signal value operation unit does not exceed the maximum luminance value displayable by the image modulation unit.

4. The apparatus according to claim 3, wherein the correction unit further includes a white balance adjustment unit adjusting a white balance with respect to the image signal having gain corrected by the gain operation unit.

5. The apparatus according to claim 1, wherein the light path shift unit includes:
a polarization rotation liquid crystal cell controlling polarization rotation of the modulation light generated by the image modulation unit; and
a birefringence plate on which modulation light from the polarization rotation liquid crystal cell is incident.

6. The apparatus according to claim 5, wherein the light path shift unit further includes a sensing unit acquiring response characteristic of the polarization rotation liquid crystal cell, and
the correction unit changes a value of parameter used for correcting the amount of modulation of modulation light to be generated by the image modulation unit in accordance with the response characteristic acquired by the sensing unit.

7. The apparatus according to claim 5, wherein the light path shift unit further includes a drive control unit controlling a drive of the polarization rotation liquid crystal cell so that a ratio of leakage light in each light path of the modulation light becomes approximately equal to each other.

8. The apparatus according to claim 5, wherein TN liquid crystal, STN liquid crystal, vertical alignment liquid crystal or IPS liquid crystal are used for the polarization rotation liquid crystal cell.

9. The apparatus according to claim 5, wherein quartz, lithium niobate, rutile, calcite, Chile saltpeter or YVO₄ is used for the birefringent plate.

10. The apparatus according to claim 1, wherein the correction unit includes:
an image processing unit carrying out image processing for eliminating an influence of the leakage light; and
a select switch selecting whether or not the image processing should be made.

11. The apparatus according to claim 1, wherein the correction unit includes:
an image processing unit carrying out image processing for eliminating an influence of the leakage light; and
a setting unit setting a level for eliminating an influence of the leakage light in the image processing.

12. The apparatus according to claim 1, wherein the correction unit includes:
an image processing unit carrying out image processing for eliminating an influence of the leakage light;
an image characteristic determination unit determining image characteristic of an input image signal; and
a setting unit setting a level for eliminating an influence of the leakage light in the image processing in accordance with the image characteristic determined by the image characteristic determination unit.

13. An image display apparatus comprising:
image modulation means for generating modulation light modulated in accordance with an image signal;
light path shift means capable of shifting a light path of the modulation light generated by the image modulation means;
projection optical means for projecting the modulation light passing through the light path shift means on a screen; and
correction means for correcting an amount of modulation of the modulation light to be generated by the image modulation means considering leakage light in a light path excluding a normal light path of the modulation light passing through the light path shift means.

14. A correction method for an image display apparatus comprising: an image modulation unit generating modulation light modulated in accordance with an image signal; and a light path shift unit capable of shifting a light path of the modulation light generated by the image modulation unit,
the method comprising: correcting an amount of modulation of the modulation light to be generated by the image modulation unit considering leakage light in a light path excluding a normal light path of the modulation light passing through the light path shift unit.

15. The method according to claim 14, wherein the image modulation unit generates modulation light with respect to each of colors, and wherein correcting the amount of modulation of the modulation light includes correcting an amount of modulation of modulation light with respect to each of the colors.

16. The method according to claim 14, wherein correcting the amount of modulation of the modulation light includes:
correcting, by a signal value operation unit, a luminance value of an image signal with respect to each of colors considering the leakage light; and
correcting, by a gain operation unit, a gain of the image signal corrected by the signal value operation unit so that the maximum luminance value of the image signal corrected by the signal value operation unit does not exceed the maximum luminance value displayable by the image modulation unit.

17. The method according to claim 16, wherein correcting the amount of modulation of the modulation light further includes adjusting, by a white balance adjustment unit, a white balance with respect to the image signal having gain corrected by the gain operation unit.

18. The method according to claim 14, wherein the light path shift unit includes:
a polarization rotation liquid crystal cell controlling polarization rotation of the modulation light generated by the image modulation unit;
a birefringence plate on which modulation light from the polarization rotation liquid crystal cell is incident; and
a sensing unit acquiring response characteristic of the polarization rotation liquid crystal cell, and
wherein correcting the amount of modulation of the modulation light includes changing a value of parameter used for correcting the amount of modulation of modulation light to be generated by the image modulation unit in accordance with the response characteristic acquired by the sensing unit.

19. The method according to claim 14, wherein correcting the amount of modulation of the modulation light includes:
carrying out image processing for eliminating an influence of the leakage light; and
selecting whether or not the image processing should be made.

20. The method according to claim 14, wherein correcting the amount of modulation of the modulation light includes:
carrying out image processing for eliminating an influence of the leakage light; and
setting a level for eliminating an influence of the leakage light in the image processing.

21. The method according to claim 14, wherein correcting the amount of modulation of the modulation light includes:
carrying out image processing for eliminating an influence of the leakage light;
determining image characteristic of an input image signal; and
setting a level for eliminating an influence of the leakage light in the image processing in accordance with the determined image characteristic.
